(19) United States
(12) Patent Application Publication
(10) Pub. No.: US 2022/0048405 A1
(43) Pub. Date: Feb. 17, 2022

(54) SYSTEM, APPARATUS, AND METHOD FOR POWERING A VEHICLE

(71) Applicant: Christopher R. Ade, Mahwah, NJ (US)

(72) Inventor: Christopher R. Ade, Mahwah, NJ (US)

(21) Appl. No.: 16/994,960

(22) Filed: Aug. 17, 2020

(51) Int. Cl. B60L 58/18; H02J 7/00; H02J 7/35; B60L 8/00; B60L 53/20; B60L 50/60

(52) U.S. Cl. CPC B60L 58/18; H02J 7/0068; H02J 7/35; B60L 50/66; B60L 8/006; B60L 53/20; B60L 8/003

(57) ABSTRACT

A method is disclosed. The method includes producing a first electrical current using a power source, charging a first power storage using the first electrical current, selectively powering a first power component using the first power storage, and driving a mechanical component using the first power component. The method also includes driving a second power component using the mechanical component, producing a second electrical current using the second power component that is driven by the mechanical component, charging a second power storage using the second electrical current, and selectively powering the first power component using the second power storage.

### TECHNICAL FIELD

The present disclosure generally relates to a system, apparatus, and method for a vehicle, and more particularly to a system, apparatus, and method for powering a vehicle.

### BACKGROUND

Most conventional vehicles typically utilize combustion engines that burn fuel such as fossil fuels to generate power. Some vehicles such as electric vehicles are electrically charged using an external energy source such as a charging station that provides electric power based on conventional energy sources such as fossil fuel power plants.

Conventional solar power approaches are limited by the relatively slow charging associated with solar power applications. For example, based on the relatively long charging times involved in using solar power, conventional vehicles typically still use fossil-fuel-based power sources such as combustion engines and/or charging stations that supply power generated from conventional power plants. These conventional power sources such as combustion engines, fossil fuel power sources, and conventional power plants cause pollution and damage to the environment. Continued use of vehicles based on these sources thereby contributes to pollution and environmental damage.

The exemplary disclosed system, apparatus, and method are directed to overcoming one or more of the shortcomings set forth above and/or other deficiencies in existing technology.

### SUMMARY OF THE DISCLOSURE

In one exemplary aspect, the present disclosure is directed to a method. The method includes producing a first electrical current using a power source, charging a first power storage using the first electrical current, selectively powering a first power component using the first power storage, and driving a mechanical component using the first power component. The method also includes driving a second power component using the mechanical component, producing a second electrical current using the second power component that is driven by the mechanical component, charging a second power storage using the second electrical current, and selectively powering the first power component using the second power storage.

In another aspect, the present disclosure is directed to a system. The system includes a power source, a first power storage that is configured to be charged by the power source, a first power component that is selectively powered by the first power storage, a mechanical component that is configured to be driven by the first power component, a second power component that is configured to be driven by the mechanical component to generate electricity, and a second power storage that is configured to be charged by the second power component. The second power storage selectively powers the first power component. The first power component is a smart inverter that controls the second power storage to begin selectively powering the first power component when the first power storage is drained.

### BRIEF DESCRIPTION OF THE DRAWINGS

FIG. 1 illustrates a schematic view of at least some exemplary embodiments of the present disclosure;

FIG. 1A illustrates a schematic view of at least some exemplary embodiments of the present disclosure;

FIG. 2 illustrates a schematic view of at least some exemplary embodiments of the present disclosure;

FIG. 3 illustrates a schematic view of at least some exemplary embodiments of the present disclosure;

FIG. 4 illustrates an exemplary process of at least some exemplary embodiments of the present disclosure;

FIG. 5 is a schematic illustration of an exemplary computing device, in accordance with at least some exemplary embodiments of the present disclosure; and

FIG. 6 is a schematic illustration of an exemplary network, in accordance with at least some exemplary embodiments of the present disclosure.

### DETAILED DESCRIPTION AND INDUSTRIAL APPLICABILITY

The exemplary disclosed system, apparatus, and method may power a vehicle. For example, the exemplary disclosed system, apparatus, and method may power any suitable vehicles such as cars and trucks (e.g., and other ground vehicles), aircraft such as fixed wing aircraft (e.g., airplanes) and rotary wing aircraft (e.g., helicopters), drones, waterborne vehicles such as boats and ships, or any other suitable vehicle.

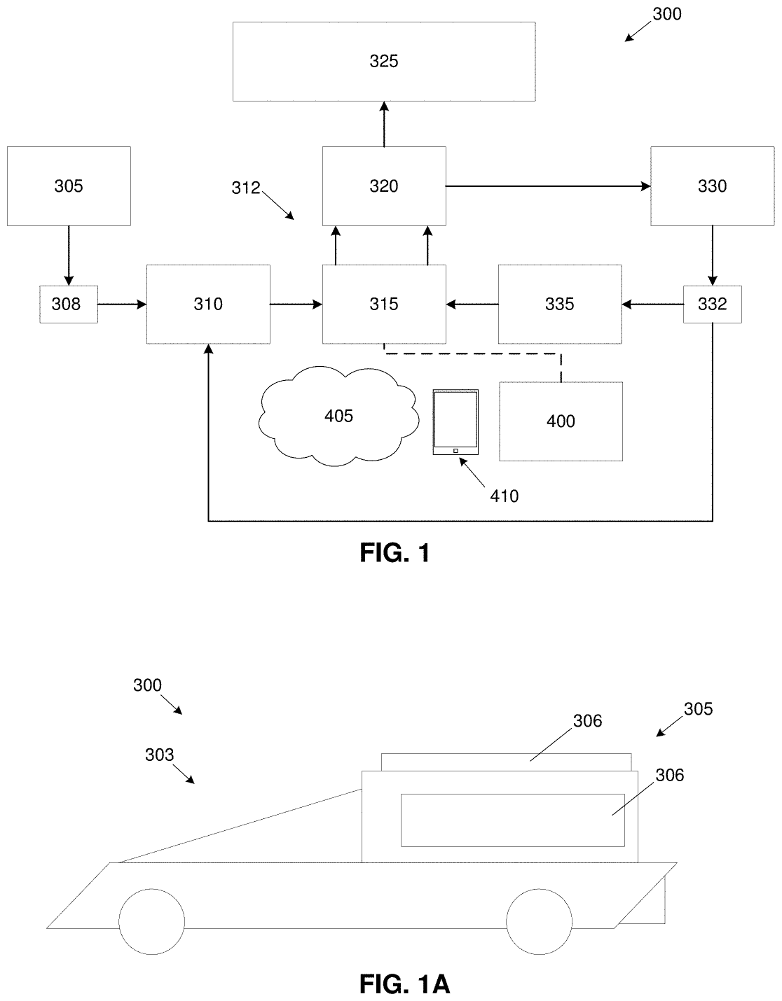

As illustrated in FIG. 1, system 300 may include a power source 305, an electrical component 308, a power storage 310, a power assembly 312, an assembly 325, an electrical component 332, and a power storage 335. Electrical component 308 may control and/or adjust power provided from power source 305 to power storage 310. Power storage 310 may provide power to power assembly 312, which may power assembly 325. Electrical component 332 may control and/or adjust power provided from power assembly 312 to power storage 335. Power storage 335 may provide power to power assembly 312. In at least some exemplary embodiments, power source 305, electrical component 308, power storage 310, power assembly 312, assembly 325, electrical component 332, and power storage 335 may be disposed on a vehicle 303 as illustrated in FIG. 1A. The exemplary disclosed components may be electrically connected by any suitable electrical connector (e.g., electrical wires, cords, and/or cables such as, for example, copper wires) for example as illustrated in FIG. 1.

Power source 305 may be any suitable power source for providing power such as electrical power to system 300. Power source 305 may be a solar energy source. For example, power source 305 may include one or more solar energy panels. Power source 305 may include thin-film, monocrystalline, and/or polycrystalline solar panels. Power source 305 may include photovoltaic (PV) and/or thermal solar energy units. Power source 305 may also include wind power energy units (e.g., wind turbine), kinetic power energy units, and/or any other desired renewable or non-renewable power sources. For example as illustrated in FIG. 1A, power source 305 may include one or more energy components 306 (e.g., solar panels or any other desired energy components) that may be attached to system 300 that may include vehicle 303.

Electrical component 308 may be any suitable component for adjusting or regulating electric power (e.g., electric current) transferred from power source 305 to power storage 310. Electrical component 308 may be any suitable charge controller. Electrical component 308 may reduce, mitigate, or substantially prevent a power surge being transferred from power source 305 to power storage 310. For example, electrical component 308 may be a maximum power point tracking (MPPT) charge controller or a pulse width modulation (PWM) charge controller. For example, electrical component 308 may be any suitable solar power charge controller or wind power charge controller. Electrical component 332 may be similar to electrical component 308. Electrical component 308 and electrical component 332 may also act as electrical switches (e.g., include electrical switch components) for example as described below regarding the exemplary disclosed electrical switch.

Power storage 310 may be any suitable energy storage component. Power storage 310 may be a rechargeable battery. For example, power storage 310 may include a nickel-metal hydride battery, a lithium-ion battery, an ultracapacitor battery, a lead-acid battery, and/or a nickel cadmium battery. Power storage 310 may be any suitable power storage that may be recharged and that may be used to provide charge to system 300. Power storage 335 may be similar to power storage 310.

Assembly 325 may be any suitable assembly that may be powered or driven by power assembly 312. For example, assembly 325 may be a powertrain assembly of a vehicle (e.g., vehicle 303) that may for example include a clutch, a transmission, a driveshaft, and/or wheels (e.g., ground vehicle powertrain components). Assembly 325 may include powertrain components of an air vehicle (e.g., similar to vehicle 303) such as a gearbox, a propeller shaft, a propeller, and/or jet components. Assembly 325 may include powertrain components of a waterborne vehicle (e.g., similar to vehicle 303) such as a universal joint, a propeller shaft, a propeller, and/or hydro-jet. Assembly 325 may include any suitable drive components of a vehicle (e.g., vehicle 303) that may be powered or driven by system 300 (e.g., by power assembly 312).

Power assembly 312 may include a power component 315, a mechanical component 320, and a power component 330. Power component 315 may power mechanical component 320, and power component 330 may be driven by mechanical component 320.

Power component 315 may be any suitable component for powering mechanical component 320. For example, power component 315 may be any suitable device for changing an electrical current between direct current (DC) and alternating current (AC). Power component 315 may change DC current provided by power storage 310 into AC power. Power component 315 may be a power inverter. Power component 315 may also include mechanical components that may be powered using the converted AC power. For example, power component 315 may include a rotary apparatus or any other suitable mechanical components. Power component 315 may be a static inverter including electrical components. In at least some exemplary embodiments, power component 315 may be a rectifier or an oscillator.

Mechanical component 320 may be any suitable component for being powered by power component 315 in order to drive assembly 325. Mechanical component 320 may be any suitable mechanical device for driving or actuating mechanical components of assembly 325 for example as described above. Mechanical component 320 may include a rotary apparatus such as a rotor. Mechanical component 320 may be mechanically and/or operably connected to assembly 325 so that mechanical components of mechanical component 320, which may be powered by power component 315, may mechanically drive mechanical components of assembly 325. For example, mechanical component 320 may be a spinning rotor that produces mechanical energy that drives assembly 325 (e.g., turns gears of assembly 325, which rotates wheels and tires of assembly 325 and/or any other desired mechanical components). In at least some exemplary embodiments, mechanical component 320 may include mechanical, electro-mechanical, magnetic, thermodynamic, and/or any other suitable components to drive assembly 325 by any suitable technique.

Power component 330 may be any suitable component for being driven by mechanical component 320. Power component 330 may be any suitable component for converting mechanical energy into electrical energy such as AC current. Power component 330 may be an electrical generator. Power component 330 may be any suitable device for using a rotating magnetic field to convert mechanical energy into electrical energy. For example, power component 330 may be an alternator. Power component 330 and mechanical component 320 may form a rotor/alternator assembly. For example, power component 330 may be an alternator that changes kinetic energy from mechanical component 320, which may include a spinning rotor, into electricity. Power component 330 may provide electrical current (e.g., AC current) to charge power storage 335 via electrical component 332.

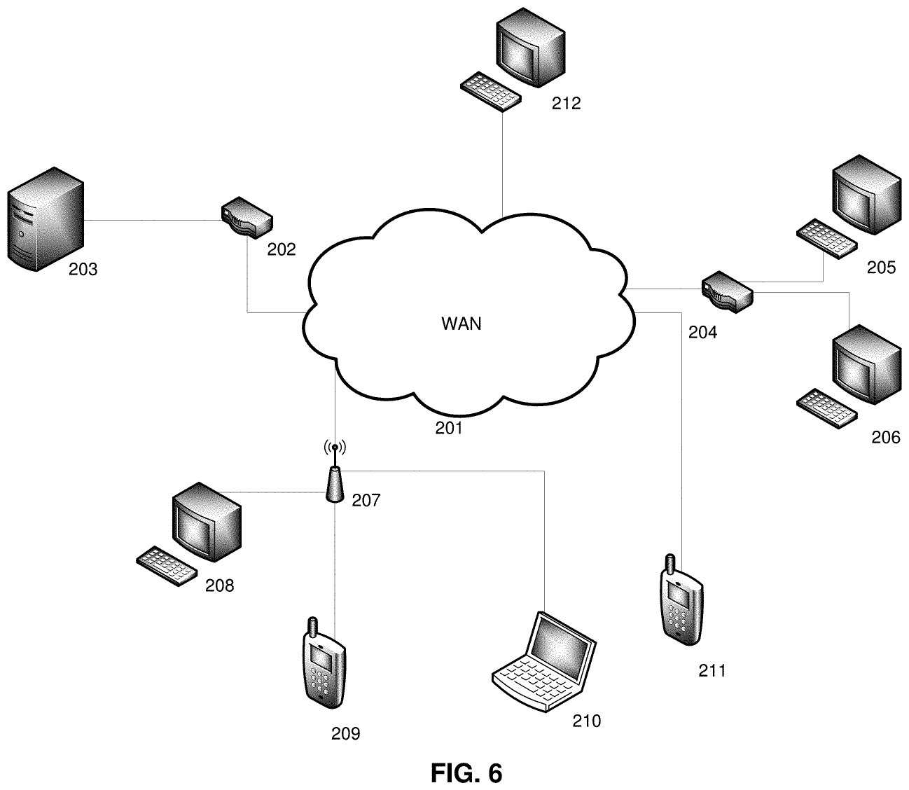

System 300 may also include a controller 400. Controller 400 may communicate with any suitable components of system 300 and/or components that operate in conjunction with system 300 such as a user device 410 and/or a network component 405. User device 410 that may communicate with controller 400 and/or network component 405 may be any suitable user device for receiving input and/or providing output (e.g., raw data or other desired information) to and from a user such as, for example, a control station or dashboard of a vehicle (e.g., a steering wheel, acceleration pedal, dashboard components, and/or any other suitable control devices of a vehicle such as vehicle 303), a touchscreen device (e.g., a smartphone, a tablet, a smartboard, and/or any suitable computer device), a computer keyboard and monitor (e.g., desktop or laptop), an audio-based device for entering input and/or receiving output via sound, a tactile-based device for entering input and receiving output based on touch or feel, a smart watch, Bluetooth headphones, a dedicated user device or interface designed to work specifically with other components of system 300, and/or any other suitable user device or interface. For example, system 300 (e.g., vehicle 303) may be controlled remotely via user device 410 and/or network component 405. Network component 405 may be a WAN such as, for example, described below regarding FIG. 6. Network component 405, user device 410, and/or controller 400 may communicate with each other and/or any other suitable component of system 300 via any suitable communication method such as, for example, wireless communication (e.g., CDMA, GSM, 3G, 4G, and/or 5G), direct communication (e.g., wire communication), Bluetooth communication coverage, Near Field Communication (e.g., NFC contactless communication such as NFC contactless payment methods), radio frequency communication (e.g., RF communication such as short-wavelength radio waves, e.g., UHF waves), and/or any other desired communication technique. For example as illustrated in FIG. 1, controller 400 may be connected to power component 315 by any suitable technique such as, for example, the exemplary communication techniques described above.

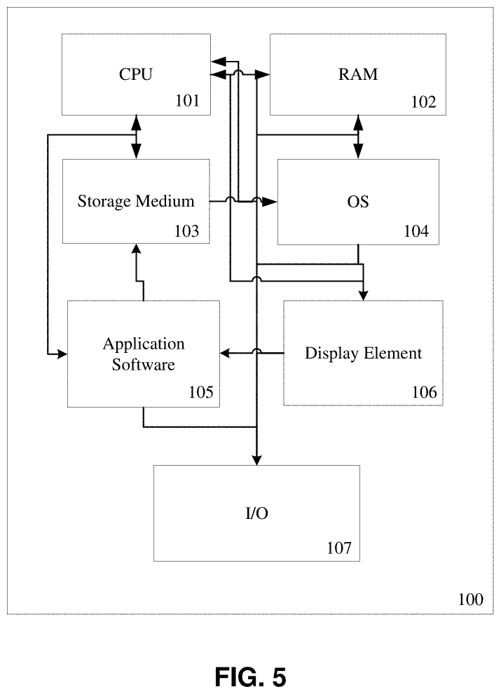

Controller 400 may control an operation of some or all components of system 300. Controller 400 may be any suitable computing device for controlling an operation of components of system 300. Controller 400 may, for example, include components similar to the components described below regarding FIG. 5. Controller 400 may include for example a processor (e.g., micro-processing logic control device) or board components. Also for example, controller 400 may include input/output arrangements that allow it to be connected (e.g., via wireless, Wi-Fi, Bluetooth, or any other suitable communication technique) to other components of system 300. For example, controller 400 may control an operation of components of system 300 based on input received from an exemplary disclosed module of system 300 (e.g., as described below).

System 300 may include one or more modules that may be partially or substantially entirely integrated with one or more components of system 300 such as, for example, controller 400, user device 410, one or more network components 405, and/or any other desired component of system 300 (e.g., power component 315). The one or more modules may be software modules as described for example below regarding FIG. 5. For example, the one or more modules may include computer-executable code stored in non-volatile memory. The one or more modules may also operate using a processor (e.g., as described for example herein). The one or more modules may store data and/or be used to control some or all of the exemplary disclosed processes described herein. In at least some exemplary embodiments, power component 315 (e.g., and/or any other desired component of system 300) may be a smart component in which the exemplary disclosed module or modules may be integrated. For example, power component 315 may be a smart component (e.g., smart inverter) that selectively allows current to flow (e.g., via inputs of power component 315) from the exemplary disclosed power storages for example as described herein.

Components of system 300 may be formed from any suitable materials such as, for example, Polycarbonate (PC), Barium (e.g., BaSO₄), silicone material, polymer material, structural metal (e.g., structural steel), co-polymer material, textile material, thermoplastic and thermosetting polymers, resin-containing material, polyethylene, polystyrene, polypropylene, epoxy resins, phenolic resins, Acrylanitrile Butadiene Styrene (ABS), Mix of ABS and PC, Acetal (POM), Acetate, Acrylic (PMMA), Liquid Crystal Polymer (LCP), Mylar, Polyamid-Nylon, Polyamid-Nylon 6, Polyamid-Nylon 11, Polybutylene Terephthalate (PBT), Polycarbonate (PC), Polyetherimide (PEI), Polyethylene (PE), Low Density PE (LDPE), High Density PE (HDPE), Ultra High Molecular Weight PE (UHMW PE), Polyethylene Terephthalate (PET), PolPolypropylene (PP), Polyphthalamide (PPA), Polyphenylenesulfide (PPS), Polystyrene (PS), High Impact Polystyrene (HIPS), Polysulfone (PSU), Polyurethane (PU), Polyvinyl Chloride (PVC), Chlorinated Polyvinyl chloride (CPVC), Polyvinylidenefluoride (PVDF), Styrene Acrylonitrile (SAN), Teflon TFE, Thermoplastic Elastomer (TPE), Thermoplastic Polyurethane (TPU), and/or Engineered Thermoplastic Polyurethane (ETPU), or any suitable combination thereof.

In at least some exemplary embodiments, system 300 (e.g., power source 305) may have solar, wind, and kinetic energy units and may not have combustion power sources (e.g., a combustion engine). For example, system 300 (e.g., power source 305) may include renewable energy sources and may not include non-renewable energy sources.

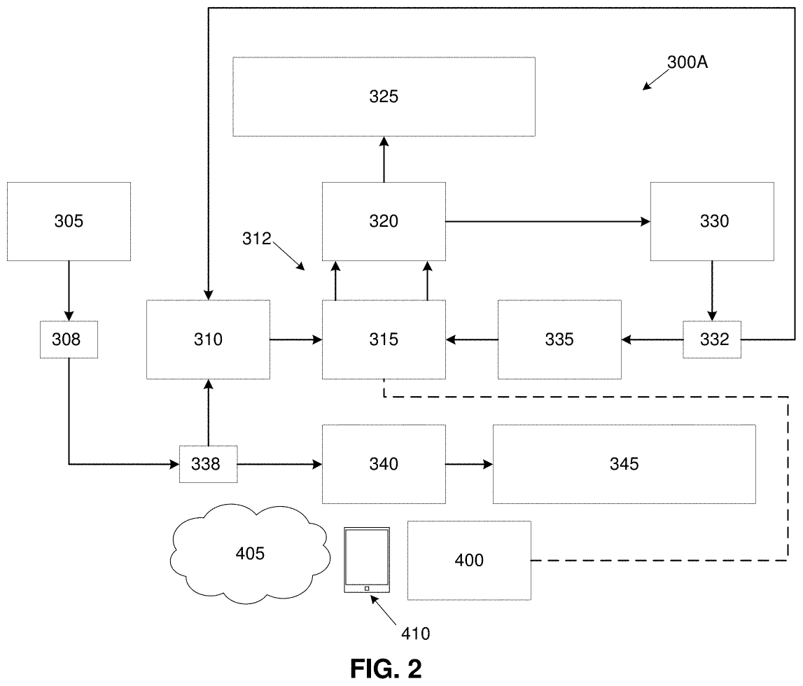

FIG. 2 illustrates another exemplary embodiment of the exemplary disclosed system, apparatus, and method. System 300A may include components similar to as described above regarding system 300. System 300A may additionally include an electrical switch 338, a power storage 340, and an assembly 345. Electrical switch 338 may selectively control current flow to power storage 310 and power storage 340, which may be similar to power storage 310. Power storage 340 may power assembly 345.

Electrical switch 338 may be any suitable electrical component for selectively allowing and blocking a current flow to power storage 310 and power storage 340. For example, electrical switch 338 may be a switch or relay such as, for example, an electrical relay, an electromagnetic relay, a solid state relay, an electromechanical relay, a hybrid relay, a reed relay, or a thermal relay. In at least some exemplary embodiments, electrical switch 338 may be a relay or switch having any desired number of poles and throws. For example, electrical switch 338 may include, e.g., one or more single pole single throw (SPST) relays, single pole double throw (SPDT) relays, double pole single throw (DPST) relays, and/or double pole double throw (DPDT) relays. Electrical component 308 and electrical component 332 may also serve as electrical switches and include components similar to electrical switch 338. In at least some exemplary embodiments, electrical component 308 and electrical switch 338 may be integrated into a single electrical component.

Assembly 345 may be any suitable assembly that may be powered by power storage 340. For example, assembly 345 may be a system or subsystem of a vehicle such as vehicle 303. For example, assembly 345 may include an electrical system, an air-conditioning system, powertrain components, a lighting system, a sound system, electrical devices, and/or any other desired assembly that may be electrically powered.

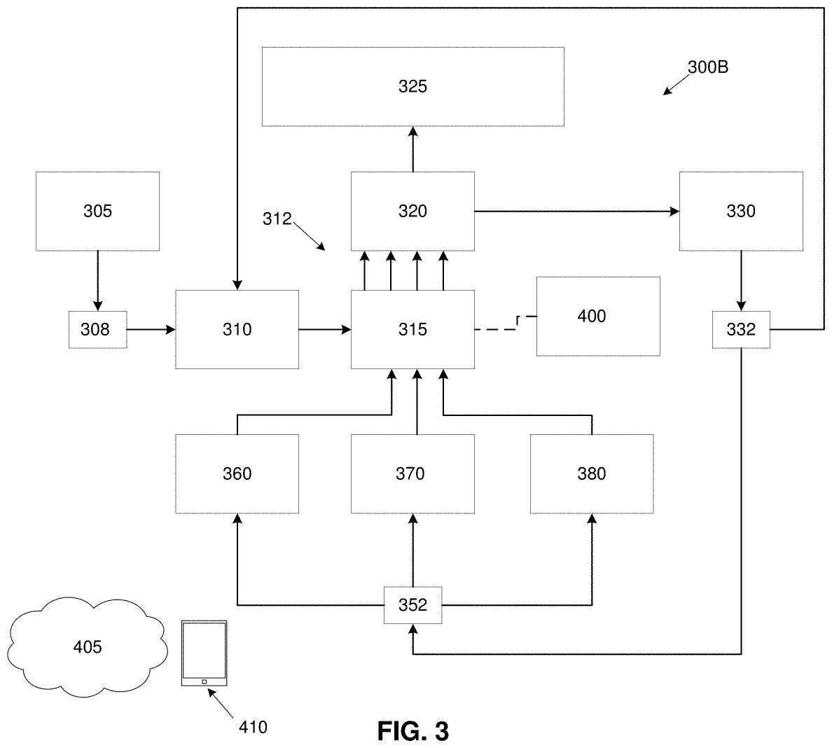

FIG. 3 illustrates another exemplary embodiment of the exemplary disclosed system, apparatus, and method. System 300B may include components similar to as described above regarding system 300. System 300B may additionally include an electrical switch 352, a power storage 360, a power storage 370, and a power storage 380. Electrical switch 352 may selectively control current flow to power storage 360, power storage 370, and power storage 380. Electrical switch 352 may be similar to electrical switch 338. Power storage 360, power storage 370, and power storage 380 may be similar to power storage 310. Additional power storages may also be provided in addition to power storage 360, power storage 370, and power storage 380.

The exemplary disclosed components of systems 300, 300A, and 300B may be combined with each other. For example, electrical switches 338 and 352, power storages 340, 360, 370, and 380, and assembly 345 may be included together with the exemplary disclosed components of system 300 (e.g., and/or systems 300A and 300B).

The exemplary disclosed system, apparatus, and method may be used in any suitable application involving powering a vehicle. For example, the exemplary disclosed system, apparatus, and method may be used in vehicles such as cars and trucks (e.g., and other ground vehicles), aircraft such as fixed wing aircraft (e.g., airplanes) and rotary wing aircraft (e.g., helicopters), drones, waterborne vehicles such as boats and ships, and/or any other suitable vehicle.

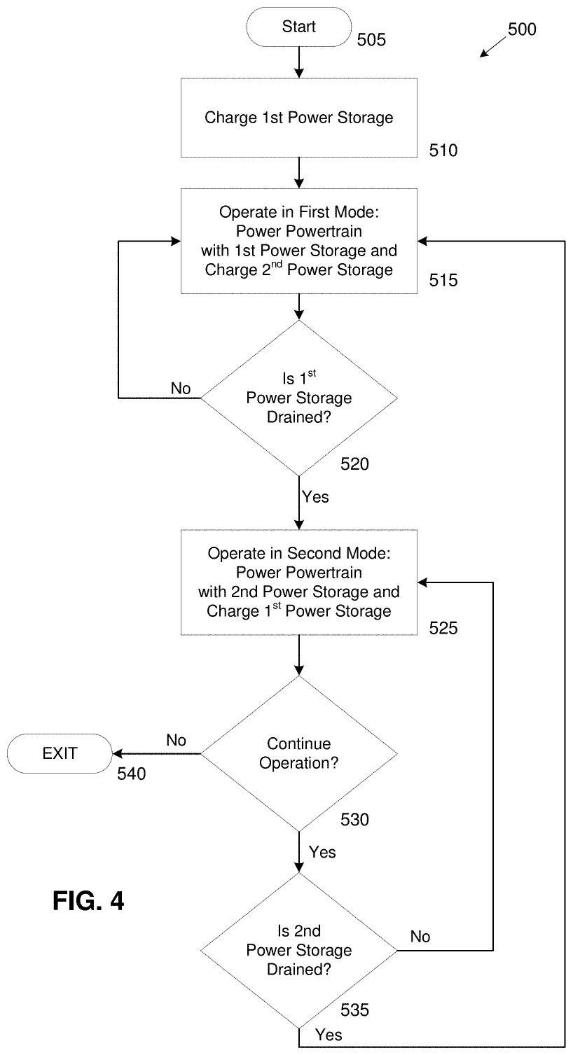

FIG. 4 illustrates an exemplary operation of system 300. Process 500 begins at step 505. The exemplary disclosed operations of process 500 may be controlled by any suitable technique such as, for example, based on predetermined algorithms provided by the exemplary disclosed module, user input provided via user device 410 and/or network component 405, predetermined time periods and/or thresholds, and/or any other suitable criteria. At step 510, power source 305 may operate to provide electrical power to power storage 310 via electrical component 308 (e.g., electrical component 308 may act as a charge controller for example as described above). Power storage 310 is thereby charged for any suitable amount of time.

At step 515, system 300 may operate in a first mode. Power storage 310 may be controlled to provide power to power component 315. Power component 315 powers mechanical component 320, which drives assembly 325. For example, vehicle 303 may thereby be operated and moved. Mechanical component 320 also drives power component 330 to provide electrical power to (e.g., to charge) power storage 335 via electrical component 332 (e.g., electrical component 332 may act as a charge controller for example as described above). Power storage 335 is thereby charged as power storage 310 is used to power component 315 to drive mechanical component 320 and assembly 325. At step 515, power storage 310 may be the primary power storage for powering system 300.

At step 520, system 300 determines whether power storage 310 still has power or charge, or whether power storage 310 is drained (e.g., empty). If power storage 310 is not drained (e.g., still has power or charge), process 500 returns to step 515 and continues to operate in the first mode. If power storage 310 is drained (e.g., can no longer provide power), process 500 proceeds to step 525.

At step 525, system 300 may operate in a second mode. Power storage 335, which may be charged as described above at step 515, may be controlled to provide power to power component 315. Power component 315 powers mechanical component 320, which continues to drive assembly 325. For example, vehicle 303 may thereby continue to be operated and moved based on power now provided by power storage 335. Mechanical component 320 also drives power component 330 to provide electrical power to power storage 310 via electrical component 332 (e.g., electrical component 332 may act as a charge controller for example as described above). Also for example as described above, electrical component 332 may act as an electrical switch to selectively switch providing current to power storage 335 (e.g., at step 515 in the first mode) and to provide current to power storage 310 (e.g., at the present step 525 in the second mode). Power storage 310 may thereby be charged as power storage 335 is used to power component 315 to drive mechanical component 320 and assembly 325 (e.g., and mechanical component 320 drives power component 330). At step 525, power storage 335 may be the primary power storage for powering system 300.

At step 530, system 300 may determine whether to continue operation (e.g., based on user input from user device 410 and/or any other suitable technique such as described above). If operation is to be continued, process 500 proceeds to step 535. If operation is to be ended, process 500 ends at step 540.

At step 535, system 300 determines whether power storage 335 still has power or charge, or whether power storage 335 is drained. If power storage 335 is not drained (e.g., still has power or charge), process 500 returns to step 525 and continues to operate in the second mode. If power storage 335 is drained (e.g., can no longer provide power), process 500 proceeds to step 515 to switch from the second mode back to the first mode. System 300 may continue to operate based on the exemplary disclosed steps of process 500 for as long and/or for as many iterations as suitable or desired.

System 300A may operate generally similarly to system 300 as described above for process 500. At step 510, electrical switch 338 may be controlled to provide electrical current from power source 305 to power storage 310 via charge controller 308. Additionally for example, at any of steps 515 through 535 (e.g., during either the first mode or the second mode), power source 305 may continue to produce power (e.g., while vehicle 303 is moving). For example while vehicle 303 is moving, electrical switch 338 is controlled to provide electrical current from power source 305 to power storage 340 via charge controller 308. Power storage 340 then provides power (e.g., electric current) to assembly 345. Assembly 345 may thereby be powered by power source 305 when system 300A is performing steps 515 through 535 (e.g., when vehicle 303 is moving).

In at least some exemplary embodiments of system 300A, electrical switch 338 may also be controlled to provide electrical current from power source 305 to power storage 310 via charge controller 308 when system 300A is performing steps 515 through 535 (e.g., when vehicle 303 is moving). Power storage 310 may thereby be charged by power source 305 when system 300A is performing steps 515 through 535 (e.g., when vehicle 303 is moving). That is, in at least some exemplary embodiments, step 510 may be performed simultaneously with steps 510 through 535.

System 300B may operate generally similarly to system 300 as described above for process 500. In addition to power storage 310 being charged by power source 305 at step 510, power storage 310 may also be charged by power source 305 when system 300B is performing steps 515 through 535 (e.g., when vehicle 303 is moving).

At step 515 when system 300B is operating in the first mode, power source 310 may be the primary battery in powering power component 315 for example as described above. At step 515, electrical switch 352 operates to selectively transfer current to power storage 360, power storage 370, and power storage 380. For example, as power source 305 continues to charge power source 310 during step 515, power storage 360 may be charged until it is substantially fully charged based on current provided from power component 330 via electrical component 332 and electrical switch 352. When power storage 360 is substantially fully charged and system 300B is still operating in the first mode according to process 500 described above, electrical switch 352 may be controlled to switch current transfer from power storage 360 to power storage 370. When power storage 370 is substantially fully charged and system 300B is still operating in the first mode according to process 500 described above, electrical switch 352 is controlled to switch current transfer from power storage 370 to power storage 380. Some or substantially all of power storages 360, 370, and 380 may thereby be charged.

When system 300B changes from the first mode to the second mode of process 500 for example as described above, any of power storage 360, power storage 370, and power storage 380 may provide power to power component 315. System 300B may thereby operate for an extended period of time in the second mode based on being powered by power storage 360 until it is drained, followed by power storage 370 until it is drained, followed by power storage 380 until it is drained (e.g., or according to any other desired order of charging). System 300B may be controlled by any suitable technique (for example as described above) to return to the first mode of operation as described above regarding process 500. For example, system 300B may control process 500 to return to step 515 (e.g., to operate in the first mode at any suitable time).

In at least some exemplary embodiments when power source 305 is a solar power source, system 300B may operate in the second mode at step 525 for as long as appropriate (e.g., when moving vehicle 303 at nighttime when power storage 310 is drained and no solar energy is available to power source 305 for charging power storage 310). For example when system 300B (e.g., vehicle 303) is solar-powered, power storages 360, 370, and 380 may provide an extended source of power for driving during the night when solar energy may not be available. System 300B may then switch back to the first mode at step 515 when some or all of power storages 360, 370, and 380 are drained and solar energy has again become available to charge power storage 310 via an operation of power source 305. System 300B may operate similarly based on an availability of wind, kinetic, and/or other renewable energy sources when power source 305 utilizes such forms of renewable energy.

In at least some exemplary embodiments, the exemplary disclosed system, apparatus, and method may simultaneously revert power from one battery to another battery. For example, the exemplary disclosed system and apparatus may have a double battery (e.g., or a plurality of any suitable number of batteries) and inverter configuration.

In at least some exemplary embodiments, the exemplary disclosed method may include producing a first electrical current using a power source (e.g., power source 305), charging a first power storage (e.g., power storage 310) using the first electrical current, selectively powering a first power component (e.g., power component 315) using the first power storage, and driving a mechanical component using the first power component. The exemplary disclosed method may also include driving a second power component using the mechanical component, producing a second electrical current using the second power component that is driven by the mechanical component, charging a second power storage (e.g., power storage 335) using the second electrical current, and selectively powering the first power component using the second power storage. The exemplary disclosed method may further include selectively powering the first power component using the first power storage at a first time period, and selectively powering the first power component using the second power storage at a second time period. The first time period may be different from the first time period. The exemplary disclosed method may also include selectively powering the first power component using the first power storage until the first power storage is drained, and beginning selective powering of the first power component using the second power storage when the first power storage is drained. The exemplary disclosed method may further include driving a mechanical assembly using the mechanical component. The power source may be a renewable power source. The first power component may be an inverter. The second power component may be an alternator. The renewable power source may be a solar power source or a wind power source. The mechanical assembly may be a powertrain assembly of a vehicle. The vehicle may include a controller that is configured to control the inverter. The exemplary disclosed method may also include switching the second electrical current between the second power storage and the first power storage, and selectively charging either the first power storage or the second power storage using the second electrical current. The exemplary disclosed method may further include switching the first electrical current between the first power storage and a third power storage, driving a mechanical assembly of a vehicle using the mechanical component, and powering a second assembly of the vehicle using the third power storage. The exemplary disclosed method may also include charging the first power storage using the first electrical current when the first power component is not driving the mechanical component that drives the mechanical assembly of the vehicle, and charging the third power storage when the first power component is driving the mechanical component that drives the mechanical assembly of the vehicle. The exemplary disclosed method may further include switching the second electrical current between the second power storage, a first additional power storage, and a second additional power storage, and selectively powering the first power component using the second power storage, the first additional power storage, and the second additional power storage. The exemplary disclosed method may also include selectively powering the first power component using the first power storage until the first power storage is drained, and beginning selective powering of the first power component using the second power storage, the first additional power storage, and the second additional power storage when the first power storage is drained.

In at least some exemplary embodiments, the exemplary disclosed system may include a power source (e.g., power source 305), a first power storage (e.g., power storage 310) that is configured to be charged by the power source, a first power component (e.g., power component 315) that is selectively powered by the first power storage, a mechanical component that is configured to be driven by the first power component, a second power component that is configured to be driven by the mechanical component to generate electricity, and a second power storage (e.g., power storage 335) that is configured to be charged by the second power component. The second power storage may selectively power the first power component, and the first power component may be a smart inverter that controls the second power storage to begin selectively powering the first power component using the second power storage when the first power storage is drained. The exemplary disclosed system may also include a first charge controller electrically disposed between the power source and the first power storage, and a second charge controller electrically disposed between the second power component and the second power storage. The exemplary disclosed system may further include a powertrain assembly of a vehicle configured to be driven by the mechanical component that is a rotor. The power source may be a solar power source including solar panels. The second power component may be an alternator. The first and second power storages may be batteries. The exemplary disclosed system may further include a first electrical switch electrically disposed between the power source and the first power storage, the first electrical switch selectively electrically connecting the power source with the first power storage and a third power storage, an electrical assembly that is electrically connected to the third power storage, and a second electrical switch electrically disposed between the second power component and the second power storage, the second electrical switch selectively electrically connecting the second power component with the second power storage, a first additional power storage, and a second additional power storage. The first power component may be selectively powered by the second power storage, the first additional power storage, and the second additional power storage.

In at least some exemplary embodiments, the exemplary disclosed method may include providing a solar power source on a vehicle (e.g., vehicle 303), producing a first electrical current using the solar power source, charging a first power storage (e.g., power storage 310) using the first electrical current, selectively powering a first power component (e.g., power component 315) using the first power storage, driving a mechanical component using the first power component, and driving a powertrain of the vehicle using the mechanical component. The exemplary disclosed method may also include driving a second power component using the mechanical component, producing a second electrical current using the second power component that is driven by the mechanical component, charging a second power storage using the second electrical current, and selectively powering the first power component using the second power storage. The exemplary disclosed method may further include switching the second electrical current between the first power storage and the second power storage, operating the vehicle in a first mode including powering the first power component using the first power storage, and charging the second power storage using the second electrical current, and operating the vehicle in a second mode including powering the first power component using the second power storage, and charging the first power storage using the second electrical current. The exemplary disclosed method may also include alternating back and forth between the first mode and the second mode, switching from the first mode to the second mode when the first power storage is drained, and switching from the second mode to the first mode when the second power storage is drained. The exemplary disclosed method may further include charging the first power storage using the first electrical current during both the first mode and the second mode. The exemplary disclosed method may also include switching the first electrical current between the first power storage and a third power storage during either the first mode or the second mode, and powering an electrical assembly of the vehicle using the third power storage. The exemplary disclosed method may further include switching the second electrical current between the second power storage, a first additional power storage, and a second additional power storage during the first mode, and selectively powering the first power component using the second power storage, the first additional power storage, and the second additional power storage during the second mode.

The exemplary disclosed system, apparatus, and method may provide an efficient and effective technique for powering vehicles without causing pollution or damage to the environment.

The exemplary disclosed system, apparatus, and method may also provide an effective technique for continuously powering a vehicle without stopping the vehicle to obtain fossil fuel energy sources or to charge the vehicle at a charging station. The exemplary disclosed system, apparatus, and method may further provide an efficient method for controlling an operation of a plurality of on-board batteries so that a vehicle may operate continuously without stopping to refuel or to recharge. The exemplary disclosed system, apparatus, and method may reduce an overall consumption of fossil fuels by large segments of society, which may significantly reduce damage to the environment and thereby materially enhance the quality of the environment.

An illustrative representation of a computing device appropriate for use with embodiments of the system of the present disclosure is shown in FIG. 5. The computing device 100 can generally be comprised of a Central Processing Unit (CPU, 101), optional further processing units including a graphics processing unit (GPU), a Random Access Memory (RAM, 102), a mother board 103, or alternatively/additionally a storage medium (e.g., hard disk drive, solid state drive, flash memory, cloud storage), an operating system (OS, 104), one or more application software 105, a display element 106, and one or more input/output devices/means 107, including one or more communication interfaces (e.g., RS232, Ethernet, Wi-Fi, Bluetooth, USB). Useful examples include, but are not limited to, personal computers, smart phones, laptops, mobile computing devices, tablet PCs, touch boards, and servers. Multiple computing devices can be operably linked to form a computer network in a manner as to distribute and share one or more resources, such as clustered computing devices and server banks/farms.

Various examples of such general-purpose multi-unit computer networks suitable for embodiments of the disclosure, their typical configuration and many standardized communication links are well known to one skilled in the art, as explained in more detail and illustrated by FIG. 6, which is discussed herein-below.

According to an exemplary embodiment of the present disclosure, data may be transferred to the system, stored by the system and/or transferred by the system to users of the system across local area networks (LANs) (e.g., office networks, home networks) or wide area networks (WANs) (e.g., the Internet). In accordance with the previous embodiment, the system may be comprised of numerous servers communicatively connected across one or more LANs and/or WANs. One of ordinary skill in the art would appreciate that there are numerous manners in which the system could be configured and embodiments of the present disclosure are contemplated for use with any configuration.

In general, the system and methods provided herein may be employed by a user of a computing device whether connected to a network or not. Similarly, some steps of the methods provided herein may be performed by components and modules of the system whether connected or not. While such components/modules are offline, and the data they generated will then be transmitted to the relevant other parts of the system once the offline component/module comes again online with the rest of the network (or a relevant part thereof). According to an embodiment of the present disclosure, some of the applications of the present disclosure may not be accessible when not connected to a network, however a user or a module/component of the system itself may be able to compose data offline from the remainder of the system that will be consumed by the system or its other components when the user/offline system component or module is later connected to the system network.

Referring to FIG. 6, a schematic overview of a system in accordance with an embodiment of the present disclosure is shown. The system is comprised of one or more application servers 203 for electronically storing information used by the system. Applications in the server 203 may retrieve and manipulate information in storage devices and exchange information through a WAN 201 (e.g., the Internet). Applications in server 203 may also be used to manipulate information stored remotely and process and analyze data stored remotely across a WAN 201 (e.g., the Internet).

According to an exemplary embodiment, as shown in FIG. 6, exchange of information through the WAN 201 or other network may occur through one or more high speed connections. In some cases, high speed connections may be over-the-air (OTA), passed through networked systems, directly connected to one or more WANs 201 or directed through one or more routers 202. Router(s) 202 are completely optional and other embodiments in accordance with the present disclosure may or may not utilize one or more routers 202. One of ordinary skill in the art would appreciate that there are numerous ways server 203 may connect to WAN 201 for the exchange of information, and embodiments of the present disclosure are contemplated for use with any method for connecting to networks for the purpose of exchanging information. Further, while this application refers to high speed connections, embodiments of the present disclosure may be utilized with connections of any speed.

Components or modules of the system may connect to server 203 via WAN 201 or other network in numerous ways. For instance, a component or module may connect to the system i) through a computing device 212 directly connected to the WAN 201, ii) through a computing device 205, 206 connected to the WAN 201 through a routing device 204, iii) through a computing device 208, 209, 210 connected to a wireless access point 207 or iv) through a computing device 211 via a wireless connection (e.g., CDMA, GSM, 3G, 4G) to the WAN 201. One of ordinary skill in the art will appreciate that there are numerous ways that a component or module may connect to server 203 via WAN 201 or other network, and embodiments of the present disclosure are contemplated for use with any method for connecting to server 203 via WAN 201 or other network. Furthermore, server 203 could be comprised of a personal computing device, such as a smartphone, acting as a host for other computing devices to connect to.

The communications means of the system may be any means for communicating data, including text, binary data, image and video, over one or more networks or to one or more peripheral devices attached to the system, or to a system module or component. Appropriate communications means may include, but are not limited to, wireless connections, wired connections, cellular connections, data port connections, Bluetooth® connections, near field communications (NFC) connections, or any combination thereof. One of ordinary skill in the art will appreciate that there are numerous communications means that may be utilized with embodiments of the present disclosure, and embodiments of the present disclosure are contemplated for use with any communications means.

The exemplary disclosed system may for example utilize collected to prepare and submit datasets and variables to cloud computing clusters and/or other analytical tools (e.g., predictive analytical tools) which may analyze such data using artificial intelligence neural networks. The exemplary disclosed system may for example include cloud computing clusters performing predictive analysis. For example, the exemplary disclosed system may utilize neural network-based artificial intelligence to predictively assess risk. For example, the exemplary neural network may include a plurality of input nodes that may be interconnected and/or networked with a plurality of additional and/or other processing nodes to determine a predicted result (e.g., a location as described for example herein).

For example, exemplary artificial intelligence processes may include filtering and processing datasets, processing to simplify datasets by statistically eliminating irrelevant, invariant or superfluous variables or creating new variables which are an amalgamation of a set of underlying variables, and/or processing for splitting datasets into train, test and validate datasets using at least a stratified sampling technique. For example, the prediction algorithms and approach may include regression models, tree-based approaches, logistic regression, Bayesian methods, deep-learning and neural networks both as a stand-alone and on an ensemble basis, and final prediction may be based on the model/structure which delivers the highest degree of accuracy and stability as judged by implementation against the test and validate datasets. Also for example, exemplary artificial intelligence processes may include processing for training a machine learning model to make predictions based on data collected by the exemplary disclosed sensors.

Traditionally, a computer program includes a finite sequence of computational instructions or program instructions. It will be appreciated that a programmable apparatus or computing device can receive such a computer program and, by processing the computational instructions thereof, produce a technical effect.

A programmable apparatus or computing device includes one or more microprocessors, microcontrollers, embedded microcontrollers, programmable digital signal processors, programmable devices, programmable gate arrays, programmable array logic, memory devices, application specific integrated circuits, or the like, which can be suitably employed or configured to process computer program instructions, execute computer logic, store computer data, and so on. Throughout this disclosure and elsewhere a computing device can include any and all suitable combinations of at least one general purpose computer, special-purpose computer, programmable data processing apparatus, processor, processor architecture, and so on. It will be understood that a computing device can include a computer-readable storage medium and that this medium may be internal or external, removable and replaceable, or fixed. It will also be understood that a computing device can include a Basic Input/Output System (BIOS), firmware, an operating system, a database, or the like that can include, interface with, or support the software and hardware described herein.

Embodiments of the system as described herein are not limited to applications involving conventional computer programs or programmable apparatuses that run them. It is contemplated, for example, that embodiments of the disclosure as claimed herein could include an optical computer, quantum computer, analog computer, or the like.

Regardless of the type of computer program or computing device involved, a computer program can be loaded onto a computing device to produce a particular machine that can perform any and all of the depicted functions. This particular machine (or networked configuration thereof) provides a technique for carrying out any and all of the depicted functions.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. Illustrative examples of the computer readable storage medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A data store may be comprised of one or more of a database, file storage system, relational data storage system or any other data system or structure configured to store data. The data store may be a relational database, working in conjunction with a relational database management system (RDBMS) for receiving, processing and storing data. A data store may comprise one or more databases for storing information related to the processing of moving information and estimate information as well one or more databases configured for storage and retrieval of moving information and estimate information.

Computer program instructions can be stored in a computer-readable memory capable of directing a computer or other programmable data processing apparatus to function in a particular manner. The instructions stored in the computer-readable memory constitute an article of manufacture including computer-readable instructions for implementing any and all of the depicted functions.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

The elements depicted in flowchart illustrations and block diagrams throughout the figures imply logical boundaries between the elements. However, according to software or hardware engineering practices, the depicted elements and the functions thereof may be implemented as parts of a monolithic software structure, as standalone software components or modules, or as components or modules that employ external routines, code, services, and so forth, or any combination of these. All such implementations are within the scope of the present disclosure. In view of the foregoing, it will be appreciated that elements of the block diagrams and flowchart illustrations support combinations of means for performing the specified functions, combinations of steps for performing the specified functions, program instruction technique for performing the specified functions, and so on.

It will be appreciated that computer program instructions may include computer executable code. A variety of languages for expressing computer program instructions are possible, including without limitation Kotlin, Swift, C #, PHP, C, C++, Assembler, Java, HTML, JavaScript, CSS, and so on. Such languages may include assembly languages, hardware description languages, database programming languages, functional programming languages, imperative programming languages, and so on. In some embodiments, computer program instructions can be stored, compiled, or interpreted to run on a computing device, a programmable data processing apparatus, a heterogeneous combination of processors or processor architectures, and so on. Without limitation, embodiments of the system as described herein can take the form of mobile applications, firmware for monitoring devices, web-based computer software, and so on, which includes client/server software, software-as-a-service, peer-to-peer software, or the like.

In some embodiments, a computing device enables execution of computer program instructions including multiple programs or threads. The multiple programs or threads may be processed more or less simultaneously to enhance utilization of the processor and to facilitate substantially simultaneous functions. By way of implementation, any and all methods, program codes, program instructions, and the like described herein may be implemented in one or more thread. The thread can spawn other threads, which can themselves have assigned priorities associated with them. In some embodiments, a computing device can process these threads based on priority or any other order based on instructions provided in the program code.

Unless explicitly stated or otherwise clear from the context, the verbs “process” and “execute” are used interchangeably to indicate execute, process, interpret, compile, assemble, link, load, any and all combinations of the foregoing, or the like. Therefore, embodiments that process computer program instructions, computer-executable code, or the like can suitably act upon the instructions or code in any and all of the ways just described.

The functions and operations presented herein are not inherently related to any particular computing device or other apparatus. Various general-purpose systems may also be used with programs in accordance with the teachings herein, or it may prove convenient to construct more specialized apparatus to perform the required method steps. The required structure for a variety of these systems will be apparent to those of ordinary skill in the art, along with equivalent variations.

In addition, embodiments of the disclosure are not described with reference to any particular programming language. It is appreciated that a variety of programming languages may be used to implement the present teachings as described herein, and any references to specific languages are provided for disclosure of enablement and best mode of embodiments of the disclosure. Embodiments of the disclosure are well suited to a wide variety of computer network systems over numerous topologies. Within this field, the configuration and management of large networks include storage devices and computing devices that are communicatively coupled to dissimilar computing and storage devices over a network, such as the Internet, also referred to as “web” or “world wide web”.

Throughout this disclosure and elsewhere, block diagrams and flowchart illustrations depict methods, apparatuses (e.g., systems), and computer program products. Each element of the block diagrams and flowchart illustrations, as well as each respective combination of elements in the block diagrams and flowchart illustrations, illustrates a function of the methods, apparatuses, and computer program products. Any and all such functions (“depicted functions”) can be implemented by computer program instructions; by special-purpose, hardware-based computer systems; by combinations of special purpose hardware and computer instructions; by combinations of general purpose hardware and computer instructions; and so on—any and all of which may be generally referred to herein as a “component”, “module,” or “system.”

While the foregoing drawings and description set forth functional aspects of the disclosed systems, no particular arrangement of software for implementing these functional aspects should be inferred from these descriptions unless explicitly stated or otherwise clear from the context.

Each element in flowchart illustrations may depict a step, or group of steps, of a computer-implemented method. Further, each step may contain one or more sub-steps. For the purpose of illustration, these steps (as well as any and all other steps identified and described above) are presented in order. It will be understood that an embodiment can contain an alternate order of the steps adapted to a particular application of a technique disclosed herein. All such variations and modifications are intended to fall within the scope of this disclosure. The depiction and description of steps in any particular order is not intended to exclude embodiments having the steps in a different order, unless required by a particular application, explicitly stated, or otherwise clear from the context.

The functions, systems and methods herein described could be utilized and presented in a multitude of languages. Individual systems may be presented in one or more languages and the language may be changed with ease at any point in the process or methods described above. One of ordinary skill in the art would appreciate that there are numerous languages the system could be provided in, and embodiments of the present disclosure are contemplated for use with any language.

It should be noted that the features illustrated in the drawings are not necessarily drawn to scale, and features of one embodiment may be employed with other embodiments as the skilled artisan would recognize, even if not explicitly stated herein. Descriptions of well-known components and processing techniques may be omitted so as to not unnecessarily obscure the embodiments.

It will be apparent to those skilled in the art that various modifications and variations can be made to the disclosed system and method. Other embodiments will be apparent to those skilled in the art from consideration of the specification and practice of the disclosed method and apparatus. It is intended that the specification and examples be considered as exemplary only, with a true scope being indicated by the following claims.

What is claimed is:

1. A method, comprising:
producing a first electrical current using a power source;
charging a first power storage using the first electrical current;
selectively powering a first power component using the first power storage;
driving a mechanical component using the first power component;
driving a second power component using the mechanical component;
producing a second electrical current using the second power component that is driven by the mechanical component;
charging a second power storage using the second electrical current; and
selectively powering the first power component using the second power storage.

2. The method of claim 1, further comprising:
selectively powering the first power component by using the first power storage at a first time period; and
selectively powering the first power component by using the second power storage at a second time period;
wherein the first time period is different from the first time period.

3. The method of claim 1, further comprising:
selectively powering the first power component using the first power storage until the first power storage is drained; and
beginning selective powering of the first power component using the second power storage when the first power storage is drained.

4. The method of claim 1, further comprising driving a mechanical assembly using the mechanical component; wherein:
the power source is a renewable power source;
the first power component is an inverter; and
the second power component is an alternator.

5. The method of claim 4, wherein:
the renewable power source is at least one selected from the group of a solar power source, a wind power source, and combinations thereof;
the mechanical assembly is a powertrain assembly of a vehicle; and
the vehicle includes a controller that is configured to control the inverter.

6. The method of claim 1, further comprising:
switching the second electrical current between the second power storage and the first power storage; and
selectively charging either the first power storage or the second power storage using the second electrical current.

7. The method of claim 1, further comprising:
switching the first electrical current between the first power storage and a third power storage;
driving a mechanical assembly of a vehicle using the mechanical component; and
powering a second assembly of the vehicle using the third power storage.

8. The method of claim 7, further comprising:
charging the first power storage using the first electrical current when the first power component is not driving the mechanical component that drives the mechanical assembly of the vehicle; and
charging the third power storage when the first power component is driving the mechanical component that drives the mechanical assembly of the vehicle.

9. The method of claim 1, further comprising:
switching the second electrical current between the second power storage, a first additional power storage, and a second additional power storage; and
selectively powering the first power component using the second power storage, the first additional power storage, and the second additional power storage.

10. The method of claim 9, further comprising:
selectively powering the first power component using the first power storage until the first power storage is drained; and
beginning selective powering of the first power component using the second power storage, the first additional power storage, and the second additional power storage when the first power storage is drained.

11. A system, comprising:
a power source;
a first power storage that is configured to be charged by the power source;
a first power component that is selectively powered by the first power storage;
a mechanical component that is configured to be driven by the first power component;
a second power component that is configured to be driven by the mechanical component to generate electricity; and
a second power storage that is configured to be charged by the second power component;
wherein the second power storage selectively powers the first power component; and
wherein the first power component is a smart inverter that controls the second power storage to begin selectively powering the first power component when the first power storage is drained.

12. The system of claim 11, further comprising:
a first charge controller electrically disposed between the power source and the first power storage; and
a second charge controller electrically disposed between the second power component and the second power storage.

13. The system of claim 11, further comprising a powertrain assembly of a vehicle configured to be driven by the mechanical component that is a rotor, wherein:
the power source is a solar power source including solar panels;
the second power component is an alternator; and
the first and second power storages are batteries.

14. The system of claim 11, further comprising:
a first electrical switch electrically disposed between the power source and the first power storage, the first electrical switch selectively electrically connecting the power source with the first power storage and a third power storage;
an electrical assembly that is electrically connected to the third power storage; and
a second electrical switch electrically disposed between the second power component and the second power storage, the second electrical switch selectively electrically connecting the second power component with the second power storage, a first additional power storage, and a second additional power storage;
wherein the first power component is selectively powered by the second power storage, the first additional power storage, and the second additional power storage.

15. A method, comprising:
providing a solar power source on a vehicle;
producing a first electrical current using the solar power source;
charging a first power storage using the first electrical current;
selectively powering a first power component using the first power storage;
driving a mechanical component using the first power component;
driving a powertrain of the vehicle using the mechanical component;
driving a second power component using the mechanical component;
producing a second electrical current using the second power component that is driven by the mechanical component;
charging a second power storage using the second electrical current; and
selectively powering the first power component using the second power storage.

16. The method of claim 15, further comprising:
switching the second electrical current between the first power storage and the second power storage;
operating the vehicle in a first mode including powering the first power component using the first power storage, and charging the second power storage using the second electrical current; and
operating the vehicle in a second mode including powering the first power component using the second power storage, and charging the first power storage using the second electrical current.

17. The method of claim 16, further comprising:
alternating back and forth between the first mode and the second mode;
switching from the first mode to the second mode when the first power storage is drained; and
switching from the second mode to the first mode when the second power storage is drained.

18. The method of claim 16, further comprising charging the first power storage using the first electrical current during both the first mode and the second mode.

19. The method of claim 16, further comprising:
switching the first electrical current between the first power storage and a third power storage during either the first mode or the second mode; and
powering an electrical assembly of the vehicle using the third power storage.

20. The method of claim 16, further comprising:
switching the second electrical current between the second power storage, a first additional power storage, and a second additional power storage during the first mode; and
selectively powering the first power component using the second power storage, the first additional power storage, and the second additional power storage during the second mode.
